(19) United States
(12) Patent Application Publication
(10) Pub. No.: US 2009/0214974 A1
(43) Pub. Date: Aug. 27, 2009

(54) TONER FOR DEVELOPING ELECTROSTATIC IMAGE, FULL COLOR TONER KIT, AND IMAGE FORMATION METHOD

(75) Inventors: Mikio KOUYAMA, Tokyo (JP); Hiroshi YAMAZAKI, Tokyo (JP); Ken OHMURA, Tokyo (JP); Kenji HAYASHI, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA BUSINESS TECHNOLOGIES, INC., Tokyo (JP)

(21) Appl. No.: 12/388,686

(22) Filed: Feb. 19, 2009

(30) Foreign Application Priority Data
Feb. 25, 2008 (JP) 2008042677

(51) Int. Cl. G03G 9/00

(52) U.S. Cl. 430/108.21; 430/97

(57) ABSTRACT

Disclosed is a toner for developing an electrostatic image, a full color toner kit comprising the toner and an image formation method employing the a full color toner kit, the toner comprising at least a resin and a colorant, wherein the colorant includes C.I. Pigment Blue 60 having a powder X-ray diffraction peak (2θ) at 6.3±0.2° and 13.0±0.2°.

This application is based on Japanese Patent Application No. 2008-042677, filed on Feb. 25, 2008 in Japanese Patent Office, the entire content of which is hereby incorporated by reference.

### FIELD OF THE INVENTION

The present invention relates to a toner for developing an electrostatic image for use in electrophotographic image formation, and particularly to a toner for developing an electrostatic image comprising C.I. Pigment Blue 60 as a colorant.

### BACKGROUND OF THE INVENTION

Recently, electrophotographic image formation using an electrostatic image developing toner (hereinafter also denoted simply as toner) has been applicable to full-color prints as well as monochromatic prints as typified in conventional documentation. As such a full-color image forming apparatus can make printed sheets by the number as required on demand without printing plates, which are required in conventional printing processes, it has been employed mainly in a short-run printing field in which a small number of prints are often ordered (see for example, Japanese Patent O.P.I. Publication No. 2005-157314).

When making a full-color print used for catalogues or printed advertisements by using a toner, the toner is required to provide color reproduction so as to be faithful to an original image. In full-color image formation, yellow, magenta and cyan toner images are superimposed to reproduce a targeted color image and each toner as a base is required to have superior color reproducibility in obtaining faithful color reproduction.

Accordingly, study on various colorants has been made in order to achieve enhanced color reproducibility of color toners.

For example, as one of typical examples of colorants for color toners, there is mentioned of copper phthalocyanine pigment. A toner using copper phthalocyanine pigment is generally used and exhibit superior light fastness, but the toner provides an image with a reflection spectrum having a higher base-line on the longer wavelength side and therefore, tends to form an image with a seemingly color-contaminated tint. Accordingly, such a pigment has been regarded as unsuitable for image formation requiring high color reproduction, as represented by prints of company logos.

Attempts have been made which improve the copper phthalocyanine pigment to develop a toner causing no color contamination (see, for example, Japanese Patent O.P.I. Publication No. 5-239368), but these attempts have not attained sufficient reduction of color contamination.

A toner using pigments such as copper phthalocyanine pigment exhibits versatility in that image quality at a level of images formed in printing inks is achieved, but is difficult to exhibit a hue angle suitable for color reproduction of a photographic image. Various studies have been made on a toner comprising a colorant capable of providing a hue angle suitable for color reproduction of a photographic image, instead of copper phthalocyanine pigment (see, for example, Japanese Patent O.P.I. Publication Nos. 5-239368 and 2006-63171).

There is known C.I. Pigment Blue 60 having an a-type crystal structure and having a powder X-ray diffraction peak (2θ) at 5.6±0.2° and 11.2±0.2°. This α-type C.I. Pigment Blue 60, whose color angle is 268 degree, has a cyan color and has a Flip Flop property that color changes due to a viewing angle. Further, the α-type C.I. Pigment Blue 60 has problems in that transfer property is poor as compared with a yellow tone or a magenta toner, resulting in so-called toner scattering, in which toner scatters around dots or lines forming images.

### SUMMARY OF THE INVENTION

An object of the invention is to provide a toner for developing an electrostatic image, which reduces the flip flop property, provides a full color image with no color contamination having high chroma and bright color tone, and has excellent light fastness. Another object of the invention is to provide a toner for developing an electrostatic image capable of fitting its hue angle to color reproduction of a photographic image, to provide a toner for developing an electrostatic image, which exhibits excellent developability, excellent transferability and high dot formation accuracy, and reduces toner scattering, and to provide a toner for developing an electrostatic image, which is capable of forming a secondary color image which is uniform and bright in the regions of from middle to high density.

The toner for developing an electrostatic image of the invention (hereinafter also referred to as the toner of the invention) comprises at least a resin and a colorant, wherein the colorant includes C.I. Pigment Blue 60 (hereinafter also referred to as C.I. Pigment Blue 60 in the invention) having a powder X-ray diffraction peak (20) at 6.3±0.2° and 13.0±0.2°.

### BRIEF EXPLANATION OF THE DRAWING

FIG. 1 is a schematic view of one example of a tandem full color image formation apparatus capable of forming an image employing a two-component developer.

### DETAILED DESCRIPTION OF THE INVENTION

The above object can be attained by any one of the following constitution.

1. A toner for developing an electrostatic image comprising at least a resin and a colorant, wherein the colorant includes C.I. Pigment Blue 60 having a powder X-ray diffraction peak (2θ) at 6.3±0.2° and 13.0±0.2°.

2. The toner for developing an electrostatic image of item 1 above, wherein the C.I. Pigment Blue 60 further has a powder X-ray diffraction peak (2θ) at 11.1±0.2°, 16.6±0.2°, 22.5±0.2°, 23.8±0.2° and 27.0±0.2°.

3. The toner for developing an electrostatic image of item 1 above, wherein the toner has a powder X-ray diffraction peak (2η) at 6.3±0.2° and 13.0±0.2°.

4. The toner for developing an electrostatic image of item 3 above, wherein the toner further has a powder X-ray diffraction peak (2η) at 11.1±0.2°, 16.6±0.2°, 22.5±0.2°, 23.8±0.2° and 27.0±0.2°.

5. The toner for developing an electrostatic image of item 1 above, wherein the toner has a volume-based median diameter of from 3 to 8 μm.

6. The toner for developing an electrostatic image of item 1 above, wherein the toner has a coefficient of variation of from 2 to 21% in the volume-based particle size distribution.

7. The toner for developing an electrostatic image of item 1 above, wherein the toner has a softening point (Tsp) of from 70 to 110° C.

8. The toner for developing an electrostatic image of item 1 above, wherein the content of the resin in the toner is from 60 to 95 weight %.

9. The toner for developing an electrostatic image of item 1 above/wherein the content of the C.I. Pigment Blue 60 in the toner is from 1 to 10 weight %.

10. A full color toner kit comprised of at least a yellow toner comprising at least a yellow colorant and a resin, a magenta toner comprising at least a magenta colorant and a resin, a toner comprising at least C.I. Pigment Blue 60 and a resin, and a black toner comprising at least a black colorant and a resin, wherein the C.I. Pigment Blue 60 has a powder X-ray diffraction peak (2θ) at 6.3±0.2° and 13.0±0.2°.

11. The full color toner kit of item 10 above, wherein the C.I. Pigment Blue 60 further has a powder X-ray diffraction peak (2θ) at 11.1±0.2°, 16.6±0.2°, 22.5±0.2°, 23.8±0.2° and 27.0±0.2°.

12. A full color toner kit comprised of a yellow toner comprising at least a yellow colorant and a resin, a magenta toner comprising at least a magenta colorant and a resin, a cyan toner comprising at least a cyan colorant and a resin, a blue toner comprising at least C.I. Pigment Blue 60 and a resin, and a black toner comprising at least a black colorant and a resin, wherein the C.I. Pigment Blue GO has a powder X-ray diffraction peak (2θ) at 6.3±0.2° and 13.0±0.2°.

13. The full color toner kit of item 12 above, wherein the C.I. Pigment Blue 60 further has a powder X-ray diffraction peak (2θ) at 11.1±0.2°, 16.6±0.2°, 22.5±0.2°, 23.8±0.2° and 27.0±0.2°.

14. An image formation method comprising the step of forming an image employing a yellow toner comprising at least a yellow colorant and a resin, a magenta toner comprising at least a magenta colorant and a resin, a toner comprising at least C.I. Pigment Blue 60 and a resin, and a black toner comprising at least a black colorant and a resin, wherein the C.I. Pigment Blue 60 has a powder X-ray diffraction peak (2θ) at 6.3±0.2° and 13.0±0.2°.

15. An image formation method comprising employing a yellow toner comprising at least a yellow colorant and a resin, a magenta toner comprising at least a magenta colorant and a resin, a cyan toner comprising at least a cyan colorant and a resin, a blue toner comprising a blue colorant and a resin, and a black toner comprising at least a black colorant and a resin, wherein the blue toner comprises C.I. Pigment Blue 60 having a powder X-ray diffraction peak (2θ) at 6.3±0.2° and 13.0±0.2°.

The toner of the present invention provides a full color image with no color contamination and with high chroma, and the toner image exhibits stable light fastness for a long time.

The toner of the invention, which can form a monochromatic color toner image with no color contamination and with excellent tint, also provides a secondary color image with a bright color tone.

Further, the toner of the invention with improved excellent tint is capable of fitting its hue angle to color reproduction of a photographic image.

The invention relates to a toner for developing an electrostatic image comprising at least a resin and a colorant, and particularly to a toner for developing an electrostatic image providing stable light fastness, as well as such a good color tone that the hue angle of the toner can fit photographic image color reproduction.

The toner of the invention provides good color tone with no color contamination. This is probably because crystallinity of the colorant (C.I. Pigment Blue 60 in the invention) is low as compared with a conventional colorant such as copper phthalocyanine type pigment. The colorant with low crystallinity easily disperses in the toner particles on account of its low crystallinity. Therefore, it is supposed that the colorant in the toner fused on fixing uniformly disperses without unevenness on a transfer sheet, providing a color image without color contamination. Further, it is supposed that when a secondary toner color image is formed, a secondary color with no contamination is obtained, since the colorant is uniformly dispersed together with many different colorants.

The low crystallinity provides relatively high solubility. It is supposed that when toner is prepared according to for example, a polymerization method, dispersibility in polymerizable monomers or dispersibility during coagulation in a resin particle dispersion is improved, resulting in uniform dispersion of the colorant in the toner particles.

Further, it is supposed that in the toner of the invention, the uniform dispersion as described above of the colorant in toner particles or in a fixed image realizes color tone without color contamination, and a stable structure of the colorant molecule itself provides sufficient light fastness.

Since the colorant is likely to uniformly disperse in toner particles or in a fixed image, it is expected that high molecular extinction coefficient is obtained, and even a small amount of the colorant provides a sufficient image density. Therefore, it is considered that it is possible to restrain the consumption amount of the toner during image formation.

Next, the present invention will be explained in detail.

The toner of the invention comprises at least a resin and a colorant, wherein the colorant includes C.I. Pigment Blue 60 having a powder X-ray diffraction peak (2θ) at 6.3±0.2° and 13.0±0.2°. Further, it is preferred that the toner of the invention has a powder X-ray diffraction peak (2θ) at 6.3±0.2° and 13.0±0.2°. The C.I. Pigment Blue 60 in the invention is preferably an indanthrone pigment having, for example, the following chemical structural skeleton:

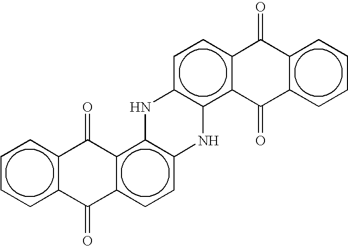

The indanthrone pigment has a deep color tone and can increase the color gamut as compared with a conventional copper phthalocyanine pigment. Further, it has excellent light fastness, and can restrain tint change. As the crystal structure of the indanthrone pigment, there is α, β, γ or δ type. The δ type is preferred in view of tint or light fastness. δ-type C.I. Pigment Blue 60, which has a powder X-ray diffraction peak (2θ) at 6.3±0.2°, 11.1±0.2°, 13.0±0.2°, 16.6±0.2°, 22.5±0.2°, 23.8±0.2° and 27.0±0.2°, is especially preferred. The δ type C.I. Pigment Blue 60 is available on the market, and there is, for example, FASTOGEN Super Blue 6101 (produced by DIC Co., Ltd.).

The δ type C.I. Pigment Blue 60 can be prepared by dissolving a type C.I. Pigment Blue 60 in a heated sulfuric acid to obtain a pigment solution, rapidly cooling it and further adding methanol thereto.

The toner of the invention may contain a phthalocyanine compound such as copper phthalocyanine in an amount of from S to 30% by weight based on the content of the C.I. Pigment Blue 60 in the invention, whereby color hue can be adjusted.

The powder X-ray diffraction peak (2θ) of the toner comprising C.I. Pigment Blue 60 used in the invention is measured according to an ordinary method. When the peak cannot be detected from powder X-ray diffraction of the toner, C.I. Pigment Blue 60 is extracted from the toner according to an ordinary method and the extracted C.I. Pigment Blue 60 is measured for the peak according to an ordinary method, whereby the peak can be detected.

The toner of the invention comprising C.I. Pigment Blue 60 in the invention as described above can provide an image with broad and stable color reproduction as compared with a conventional toner image and a printing ink image.

Particularly in recent years, opportunities have been increased which outputs a graphic image formed on a display employing a computer. The color gamut of an image formed according to a conventional color printing method or a color electro-photographic method is far narrower than that of an image formed on a display, and therefore, the image on the display cannot be output on a paper as it is. However, the toner of the invention can increase the color gamut of an output image, resulting in the output image with color gamut close to that of an image on a display.

Next, the particle size of the toner of the invention will be explained.

It is preferred that the toner of the invention has a volume-based median diameter (also denoted simply as D50v) of from 3 to 8 μm. The volume-based median diameter falling within the foregoing region can provide a fine dot image faithfully reproduced, for example, at a level of 1200 dpi (dpi represents the number of dots per inch or 2.54 cm).

One object of the invention is to provide the toner of the invention capable of faithfully carrying out a color reproduction of a photographic image. Such a minute particle size level that the volume-based median diameter falls within the range as described above lessens the size of the dots constituting a photographic image, and makes it possible to obtain a photographic image with precision which is identical to or higher than a printed image. Specifically, in on-demand printing, in which orders for several hundreds to several thousands sets are received, high image quality prints with high-precision photographic images can be delivered to a user.

The volume-based median diameter (D50v) of toner particles can be determined using Multisizer 3 (produced by Beckmann Coulter Co.), connected to a computer system for data processing.

The measurement procedure is as follows: 0.02 g of toner are added to 20 ml of a surfactant-containing solution (for example, a surfactant-containing solution obtained by diluting a surfactant-containing neutral detergent with pure water by a factor of 10) and subjected to ultrasonic dispersion to prepare a toner dispersion. Using a pipette, the toner dispersion is poured into a beaker having ISOTON II (produced by Beckman Coulter Co.) within a sample stand, until reaching a measurement concentration of 5 to 10%. The measurement count was set to 2,500 to perform measurement. The aperture diameter of Multisizer 3 is 50 μm.

The toner of the invention has a coefficient of variation (CV value) in the volume-based particle size distribution of preferably from 2 to 21%, and more preferably from 5 to 15%.

The coefficient of variation (CV value) in the volume-based particle size distribution represents a dispersion degree of toner particle size, in terms of volume and defined by the following formula.

CV value (%)=(standard deviation in the volume-based particle size distribution)×100/{median diameter (D50v) in the volume-based particle size distribution}

A lower value of CV indicates a sharper particle size distribution, and means that the particle size tends to be uniform. Uniform particle size enables more precise reproduction of fine-dot images or fine lines, which is required in digital image formation. Printing a photographic image with uniform-sized toner particles results in photographic images of high image quality at a level equivalent to or higher than an image prepared by printing ink.

The toner of the invention has a softening point (Tsp) of preferably from 70 to 110° C., and more preferably 70 to 100° C. Colorants used in the toner of the invention are stable and do not cause any change in the spectrum even when heat is applied. A softening point falling with the foregoing range can reduce effects of heat applied to the toner on fixing. Accordingly, image formation is performed without relying on a colorant, so that a broad stable color reproduction is expected.

A toner with a softening point falling within the foregoing range enables fixing a toner image at a temperature lower than the prior art, rendering it feasible to perform image formation at reduced power consumption and friendly to environments.

The softening point of toner can be controlled by the following methods, singly or in combination thereof.
(1) the kind or the composition of monomer used for resin formation is adjusted;
(2) the molecular weight of a resin is controlled by the kind or the amount of a chain transfer agent;
(3) the kind or amount of a wax is controlled.

The softening point of a toner may be measured by using, for example, Flow Tester CFT-500 (produced by Shimazu Seisakusho Co., Ltd.). Specifically, a sample which is molded to a 10 mm high column, is compressed by a plunger at a load of 1.96×10⁶ Pa while heating at a temperature rising rate of 6° C./min, and extruded from a nozzle with a length of 1 mm and a diameter of 1 mm, whereby a curve (softening flow curve) between plunger-drop and temperature is drawn. The temperature at which flowing-out is initiated is defined as a melt-initiation temperature, and the temperature corresponding to a 5 mm drop is defined as a softening temperature.

Next, a method of preparing the toner of the invention will be explained.

The toner of the invention is comprised of particles (hereinafter also referred to as colored particles) containing at least a resin and a colorant. The toner of the invention can be prepared according a conventional toner preparing method, which is not specifically limited. That is, the toner can be prepared applying a so-called pulverizing method, in which toner is prepared through kneading, pulverizing and classification, or a so-called polymerization toner preparation method in which a polymerizable monomer is polymerized and at the same time particle formation is carried out while controlling the shape or size of the particles (for example, an emulsion polymerization method, a suspension polymerization method or a polyester elongation method).

When the toner of the invention is prepared through a pulverizing method, kneading is preferably performed at a temperature of not more than 130° C. When a mixture is kneaded at a temperature exceeding 130° C., heat applied to the mixture tends to change the aggregation state of a colorant in the mixture, rendering it difficult to maintain uniform aggregation of the colorant. There is problem in that variation in the aggregation state causes variations in color tone of the prepared toner, resulting in color contamination.

Next, resin or wax constituting the toner of the invention will be explained with reference to typical examples.

A resin usable for the toner of the invention is not specifically limited, and is typically a polymer prepared by polymerization of polymerizable monomers which are called vinyl monomers. A polymer constituting a resin usable in the invention is a polymer prepared by polymerization of at least one polymerizable monomer, which is a polymer prepared by using vinyl monomers singly or in combination.

Typical examples of a polymerizable vinyl monomer will be listed below:

### (1) Styrene or Styrene Derivatives:

styrene, o-methylstyrene, m-methylstyrene, p-methylstyrene, methylstyrene, p-phenylstyrene, p-ethylstyrene, 2,4-dimethylstyrene, p-tert-butylstyrene, p-n-hexylstyrene, p-n-octylstyrene, p-n-nonylstyrene, p-n-decylstyrene, and p-n-dodecylstyrene;

### (2) Methacrylic Acid Ester Derivatives:

methyl methacrylate, ethyl methacrylate, n-butyl methacrylate, iso-propyl methacrylate, iso-butyl methacrylate, t-butyl methacrylate, n-octyl methacrylate, 2-ethylhexyl methacrylate, stearyl methacrylate, lauryl methacrylate, phenyl methacrylate, diethylaminoethyl methacrylate and dimethylaminoethyl methacrylate;

### (3) Acrylic Acid Ester Derivatives:

methyl acrylate, ethyl acrylate, iso-propyl acrylate, n-butyl acrylate, t-butyl acrylate, iso-butyl acrylate, n-octyl acrylate, 2-ethylhexyl acrylate, stearyl acrylate, lauryl acrylate and phenyl acrylate;

### (4) Olefins:

ethylene, propylene and isobutylene;

### (5) Vinyl Esters:

vinyl propionate, vinyl acetate and vinyl benzoate;

### (6) Vinyl Ethers:

vinyl methyl ether and vinyl ethyl ether;

### (7) Vinyl Ketones:

vinyl methyl ketone, vinyl ethyl ketone and vinyl hexyl ketone;

### (8) N-Vinyl Compounds:

N-vinyl carbazole, N-vinyl indole and N-vinyl pyrrolidone;

### (9) Others:

vinyl compounds such as vinylnaphthalene and vinylpyridine; acrylic acid or methacrylic acid derivatives such as acrylonitrile, methacrylonitrile and acrylamide.

As the polymerizable vinyl monomer constituting the resin used in the toner of the invention, ones having an ionic dissociation group as described later can be used. As the resin used in the toner of the invention, a resin derived from a monomer having in the side chain an ionic dissociation group such as a carboxyl group, a sulfonic acid group or a phosphoric acid group is preferably used, whereby dispersion in the resin of the colorant used in the invention can be improved. Typical examples of such a monomer will be shown below.

Typical examples of a monomer having a carboxyl group include acrylic acid, methacrylic acid, maleic acid, itaconic acid, cinnamic acid, fumaric acid, monoalkyl maleate, and monoalkyl itaconate. Typical examples of the monomers having a sulfonic acid group include styrene sulfonic acid, allylsulfosuccinic acid, and 2-acrylamido-2-methylpropane sulfonic acid. Typical examples of the monomers having a phosphoric acid group include acid phosphooxyethyl methacrylate.

Further, a cross-linked resin can be prepared using polyfunctional monomers described below.

Typical examples of the polyfunctional monomers include divinylbenzene, ethylene glycol dimethacrylate, ethylene glycol diacrylate, triethylene glycol dimethacrylate, triethylene glycol diacrylate, neopentylglycol dimethacrylate and neopentylglycol diacrylate.

As the resin used in the invention, there is a polyester resin obtained by polycondensation of an acid anhydride or a polycarboxylic acid having two or more carboxyl groups with a polyhydric alcohol having two or more hydroxyl group. Examples of the acid anhydride or the polycarboxylic acid include an aliphaatic dicarboxylic acid such as oxalic acid, malonic acid, maleic acid, fumaric acid, citraconic acid, itaconic acid, glucuronic acid, succinic acid, adipic acid, sebacic acid, azelaic acid, n-dodecylsuccinic acid or n-dodecenylsuccinic acid; an alicyclic dicarboxylic acid such as hexane dicarboxylic acid; and an aromatic dicarboxylic acid such as phthalic acid, isophthalic acid, or terephthalic acid. Examples of the polycarboxylic acid having three or more carboxylic acid include trimellitic acid, pyromellitic acid and citric acid. These polycarboxylic acids may be used as an admixture of two or more kinds thereof.

Examples of the polyhydric alcohol include an aliphatic diol such as 1,2-propane diol, 1,3-propane diol, 1,4-butane diol, 1,5-pentane diol, 1,6-hexane diol, 1,7-heptane diol, 1,2-octane diol, neopentyl glycol or 1,4-butene diol; an aromatic diol such as an adduct of hisphenol A with alkylene oxide; and a polyol such as glycerin, pentaerythritol, trimethylol propane or sorbitol. These polyhydric alcohols may be used as an admixture of two or more kinds thereof.

The resin content of the toner of the invention is preferably from 60 to 95% by weight, and more preferably from 70 to 90% by weight.

The toner of the invention can contain waxes. The waxes usable in the toner of the invention are those known in the art as listed below:

### (1) Polyolefin Wax

polyethylene wax and polypropylene wax;

### (2) Long Chain Hydrocarbon Wax

paraffin wax and sasol wax;

### (3) Dialkylketone Wax

distearylketone;

### (4) Ester Wax

carnauba wax, montan wax, trimethylolpropane tribehenate, pentae ythritol tetramyristate, pentaerythritol tetrastearate, pentaerythritol tetrabehenate, pentaerythritol diacetate dibehenate, glycerin tribehenate, 1,18-octadecanediol distearate, trimellitic acid tristarate, and distearyl meleate; (5) Amide Wax ethylenediamine dibehenylamide and trimellitic acid tristearylamide.

The melting point of wax is ordinarily 40 to 125° C., preferably 50 to 120° C., and still more preferably 60 to 90° C. A melting point falling within the foregoing range ensures heat stability of toners and can achieve stable toner image formation without causing cold offsetting even when fixed at a relatively low temperature. The wax content of the toner is in the range of preferably from 1 to 30% by weight, and more preferably from 5 to 20% by weight.

It is preferred that C.I. Pigment Blue 60 in the invention is dispersed in the toner in the form of particles having a number average primary particle size of from 10 to 300 nm. The content of the C.I. Pigment Blue 60 in the toner is preferably from 1 to 10% by weight, and more preferably from 2 to 8% by weight. The above content range of C.I. Pigment Blue 60 is advantageous in increasing color density and improving charging properties without its separation or adhesion to a carrier.

The number average primary particle size of the toner is measured employing an electron microscope photograph of the section of the toner enlarged by a factor of 50,000, which are photographed through a transmission type electron microscope. The Feret's diameters of arbitrary 10 toners in the photograph are measured and the average is defined as a number average primary particle size of the toner.

In the invention, a full color toner image can be formed employing plural colored toners to be described below. That is, a full color toner image can be formed employing a full color toner kit comprised of at least four kinds of toners, the four kinds of toners being a toner comprising at least C.I. Pigment Blue 60 in the invention and a resin, a yellow toner comprising at least a yellow colorant and a resin, a magenta toner comprising at least a magenta colorant and a resin, and a black toner comprising at least a black colorant and a resin.

As a full color toner kit is preferred the following one, which makes it possible to form an image with a bright secondary color. That is, the full color toner kit is comprised of at least five kinds of toners, the five kinds of toners being a yellow toner comprising at least a yellow colorant and a resin, a magenta toner comprising at least a magenta colorant and a resin, a cyan toner comprising at least a cyan colorant and a resin, a toner comprising at least C.I. Pigment Blue 60 in the invention and a resin, and a black toner comprising at least a black colorant and a resin.

As the colorants usable for a full color toner kit, there are mentioned of the following ones. Examples of the black colorant for the black toner include carbon black, magnetic materials and titanium black. Typical examples of carbon black include Channel Black, Furnace Black, Acetylene Black, Thermal Black and Lamp Black. Typical examples of magnetic materials include ferromagnetic metals such as iron, nickel and cobalt; alloys containing ferromagnetic metals; ferromagnetic compounds such as ferrite and magnetite; and alloys, which do not contain ferromagnetic metals but are subjected to heat treatment to exhibit ferromagnetic property, for example, alloys called Heusler alloys such as manganese-copper-aluminum and manganese-copper-tin, or chromium dioxide.

Examples of the yellow colorant for the yellow toner include C.I. Solvent Yellow 19, 44, 77, 79, 81, 82, 93, 98, 103, 104, 112, and 162 as a dye; C.I. Pigment Yellow 14, 17, 74, 93, 94, 138, 155, 180 and 185 as a pigment; and a mixture thereof. Of these, C.I. Pigment Yellow 74 is especially preferred.

Examples of the magenta colorant for the magenta toner include C.I. Solvent Red 1, 49, 52, 58, 63, 111, and 122 as a dye; C.I. Pigment Red 5, 48:1, 53:1, 57:1, 122, 139, 144, 149, 166, 177, 178 and 222 as a pigment; and a mixture thereof. Of these, C.I. Pigment Red 122 is especially preferred.

The number average primary particle size of these colorants dispersed in the toner is preferably from 10 to 200 nm, although it differs due to kinds of the colorants. The content of the colorants in the toner is preferably from 1 to 10 weight %, and more preferably from 2 to 8 weight %. The above content range of the colorant is advantageous in increasing color density and improving charging properties without its separation or adhesion to a carrier. A full color toner image can be formed employing a full color toner kit comprised of a yellow, magenta, black toner each comprising the colorant described above and a toner comprising C.I. Pigment Blue 60 in the invention.

During a process of manufacturing the toner of the invention or the toner constituting the full color toner kit of the invention; the toner may be added with inorganic or organic particles having a number average primary particle size of from 4 to 800 nm as an external additive.

Addition of the external additive improves fluidity or electrostatic property of toner and achieves enhanced cleaning ability. The kind of the external additives is not specifically limited, and examples thereof include inorganic particles, organic particles and a lubricant, as described below.

There are usable commonly known inorganic particles and preferred examples thereof include silica, titania, alumina and strontium titanate particles. There may optionally be used inorganic particles which have been subjected to hydrophobilization treatment.

Specific examples of silica particles include R-805, R-97G, R-974, R-972, R-812 and R-809 which are commercially available from Nippon Aerosil Co., Ltd.; HVK-2150 and H-200 which are commercially available from Hoechst Co.; and TS-720, TS-530, TS-610, H-5 and MS-5 which are commercially available from Cabot Co.

Examples of titania particles include T-805 and T-604 which are commercially available from Nippon Aerosil Co. Ltd.; MT-100S, MT-100B, MT-500BS, MT-600, MT-600SS, JA-1 which are commercially available from Teika Co.; TA-300SI, TA-500, TAF-130, TAF-510 and TAF-510T which are commercially available from Fuji Titan Co., Ltd.; and IT-S, IT-OA, IT-OB and IT-OC which are commercially available from Idemitsu Kosan Co., Ltd.

Examples of alumina particles include RFY-C and C-604 which are commercially available from Nippon Aerosil Co., Ltd.; and TTO-55, which is commercially available from Ishihara Sangyo Co., Ltd.

Spherical organic particles having a number-average primary particle size of 10 to 2000 nm are usable as the organic particles. Specifically, there is usable a homopolymer or copolymer of styrene or methyl methacrylate.

Lubricants such as a metal salt of a higher fatty acid can be used in order to achieve enhanced cleaning ability or transferability. Examples of the metal salt of the higher fatty acid include a zinc, copper, magnesium or calcium salt of stearic acid; a zinc, manganese, iron, copper or magnesium salt of oleic acid; a zinc, copper, magnesium or calcium salt of palmitic acid; a zinc or calcium salt of linolic acid; and a zinc or calcium salt of ricinolic acid.

The content of such an external additive or lubricant in the toner is preferably from 0.1 to 10.0% by weight. Addition of the external additive or lubricant can be conducted using various known mixing devices such as a turbuler mixer, a Henschel mixer, a Nauter mixer and a V-shape mixer.

The toner of the invention is usable as a two-component developer comprised of a carrier and a toner or as a non-magnetic single-component developer comprised of a toner alone.

The use of the toner of the invention as a two-component developer enables full-color printing by using a tandem system image formation apparatus, as described later.

As a carrier which is magnetic particles used in a two component developer, there can be used known materials, e.g., metals such as iron, ferrite and magnetite and alloys of the foregoing metals and a metal such as aluminum or lead. Of these, ferrite particles are preferred. The volume-average particle size of a carrier is preferably from 15 to 100 μm, and more preferably from 25 to 80 μm.

When image formation is carried out employing a non-magnetic single-component developer without a carrier, the toner is charged by being rubbed or pressed onto the surface of a charging member or a developing roller. Image formation employing a nonmagnetic single-component development system can simplify the structure of a developing device, resulting in advantages of manufacturing a compact image formation apparatus. Therefore, when the toner of the invention is employed as a single-component developer, a full-color printing can be conducted through a compact color printer, making it feasible to prepare full-color prints of excellent color reproduction even in a space-limited working environment.

Next, an image formation method employing the toner of the invention will be explained.

In the invention, an image formation method for forming a full color toner image can be realized using plural kinds of toners to be described below. The method is one in which a full color image is formed employing at least four kinds of toners, a toner comprising at least C.I. Pigment Blue 60 in the invention and a resin, a yellow toner comprising at least a yellow colorant and a resin, a magenta toner comprising at least a magenta colorant and a resin, and a black toner comprising at least a black colorant and a resin.

The image formation method is preferably a method to be described below. When image formation is carried out employing the following method, an image with bright secondary color can be formed. That is, the method is one in which a full color image is formed employing at least five kinds of toners, a yellow toner comprising at least a yellow colorant and a resin, a magenta toner comprising at least a magenta colorant and a resin, a cyan toner comprising at least a cyan colorant and a resin, a toner comprising at least C.I. Pigment Blue 60 in the invention and a resin, and a black toner comprising at least a black colorant and a resin.

These image formation methods will be explained in more detail.

An image formation method employing the toner of the invention as a two-component developer will be explained.

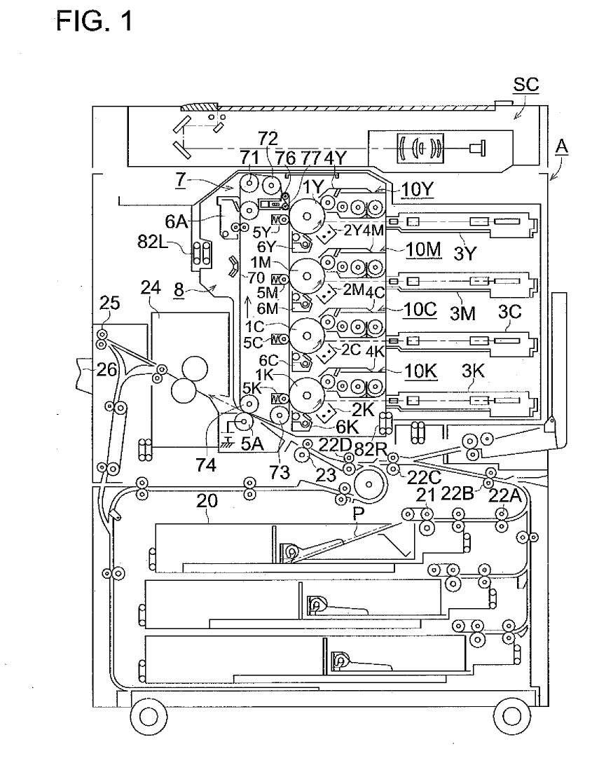

FIG. 1 is a schematic view of one example of an image formation apparatus in which the toner of the invention is usable as a two-component developer.

In FIG. 1, 1Y, 1M, 1C and 1K each designate a photoreceptor; 4Y, 4M, 4C and 4K each designate a developing device; 5Y, 5M, 5C and 5K each designate a primary transfer roller as a primary transfer means; 5A designates a secondary transfer roller as a secondary transfer means; 6Y, 6M, 6C and 6K each designate a cleaning means; the numeral 7 designates an intermediate transfer unit; the numeral 24 designates a thermal roll fixing device; and the numeral 70 designates an intermediate transfer material.

This image formation apparatus is called a tandem color image formation apparatus, which is composed of a housing 8 comprising plural image formation sections 10Y, 10M, 10C and 10B and an endless belt intermediate transfer material unit 7 as a transfer section, a paper feeding and conveying means 21 to convey recording member P, and a heat roll fixing device 24 as a fixing means. A reading device SC for reading an original is disposed in the upper section of the image formation apparatus body A. The housing 8 is disposed in the image formation apparatus body A so that it can be pulled out from the image formation apparatus body A through supporting rails 82L and 82R.

Image formation section 10Y to form a yellow image as one of a different color toner image formed on the respective photoreceptors comprises a drum-shaped photoreceptor 1Y as a first photoreceptor and disposed around the photoreceptor 1Y, a charging means 2Y, an exposure means 3Y, a developing means 4Y, a primary transfer roller 5Y as a primary transfer means and a cleaning means 6Y. Image formation section 10M to form a magenta image as one of another different color toner image comprises a drum-shaped photoreceptor 1M as a first photoreceptor and disposed around the photoreceptor 1M, a charging means 2M, an exposure means 3M, a developing means 4M, a primary transfer roller 5M as a primary transfer means and a cleaning means 6M. Image formation section 10C to form a magenta image as one of still another different color toner image comprises a drum-shaped photoreceptor 1C as a first photoreceptor and disposed around the photoreceptor 1C, a charging means 2C, an exposure means 3C, a developing means 4C, a primary transfer roller 5C as a primary transfer means and a cleaning means 6C. Image formation section 10K to form a magenta image as one of still further another different color toner image comprises a drum-shaped photoreceptor 1K as a first photoreceptor and disposed around the photoreceptor 1k, a charging means 2K, an exposure means 3K, a developing means 4K, a primary transfer roller 5K as a primary transfer means and a cleaning means 6K.

An endless belt intermediate transfer unit 7, which is turned by plural rollers 71, 72, 73, 74, 76 and 77, comprises an endless belt intermediate transfer material 70 as a second image carrier in the endless belt form, which is pivotably supported.

The individual color images formed in image formation sections 10Y, 10M, 10C and 10K are successively transferred onto the rotating endless belt intermediate transfer material 70 by primary transfer rollers 5Y, 5M, 5C and 5K, respectively, to form a composite color image. Recording member P such as paper or the like as a transfer material housed in paper feed cassette 20 is fed by a paper feed and conveyance means 21 and conveyed to a secondary transfer roller 5A through plural intermediate rollers 22A, 22B, 22C and 22D and a resist roller 23, where color images are transferred together on recording member P The recording member P with the transferred color images is fixed by a heat-roll type fixing device 24, nipped by a paper discharge roller 25, and put onto a paper discharge tray 26 outside a machine.

After a color image is transferred onto recording member P by a secondary transfer roller 5A, any residual toner which remains on the endless belt intermediate transfer material 70 from which the recording member P is separated is removed by a cleaning means 6A.

During image formation, the primary transfer roller 5K is always in contact with the photoreceptor 1K. Other primary rollers 5Y, 5M and 5C are brought into contact with the photoreceptors 1Y, 1M and 1C, respectively, only at the time when color images are formed on the photoreceptors 1Y, 1M and 1C.

The secondary transfer roller 5A is brought into contact with the endless belt intermediate transfer material 70 only when secondary transfer to recording material P is carried out.

Thus, toner images are formed on photoreceptors 1Y, 1M, 1C and 1K, through electrostatic-charging, exposure and development. The resulting toner images having a different color are superimposed on the endless belt intermediate transfer material 70, transferred together onto recording member P and fixed by compression and heating in the heat-roll type fixing device 24. After completion of transferring a toner image to recording member P, any toner remained on the photoreceptors 1Y, 1M, 1C and 1K is removed by cleaning device 6A, whereby the intermediate transfer material 70 is cleaned, and then goes into the foregoing cycle of electrostatic-charging, exposure and development to perform the subsequent image formation.

When the toner of the invention is used as a non-magnetic single-component developer for image formation, the two-component developing means are changed to a nonmagnetic single-component developing means.

The fixing method is not specifically limited, and may be any fixing method. There are, for example, a method employing a heat roller and a pressure roller, a method employing a heat roller and a pressure belt, a method employing a heat belt and a pressure roller, and a method employing a heat belt and a pressure belt. As heating methods, any known heating methods such as a method employing a halogen lamp and a method employing IH may be used.

### EXAMPLES

The embodiments of the invention will be explained employing examples, but the invention is by no means limited to these.

### 1. Preparation of Developer

### Example 1

### Preparation of Toner Via Kneading-Pulverizing Method

The toner composition described below was placed in a HENSCHEL MIXER (produced by Mitsui-Miike Kogyo Co., Ltd.) and mixed with stirring at a blade-circumferential speed of 25 m/sec for 5 min.

| | |
|---|---|
| Polyester resin (condensation product | 100 weight parts |
| of bisphenol A-ethylene oxide adduct, | |
| terephthalic acid and trimellitic acid) | |
| C.I. Pigment Blue 60 (δ type) | 5 weight parts |
| Releasing agent | 6 weight parts |
| (pentaerythritol tetrastearate) | |
| Charge controlling agent | 1 weight part |
| (boron dibenzylic acid complex) | |

C.I. Pigment Blue 60 (δ type) as described above had a powder X-ray diffraction peak (2θ) at 6.3°, 11.1°, 13.0°, 16.6°, 22.5°, 23.8° and 27.0 .

The resulting mixture was kneaded in a biaxial extrusion kneader, roughly pulverized in a hammer mill, further pulverized in a turbo-mill (produced by TURBO KOGYO Co., Ltd.), and subjected to powder classification in an air classifier employing Coanda effect to obtain colored particles having a volume-based median diameter of 5.5 μm.

Next, the following external additives were added to the resulting colored particles, and subjected to external treatment in a HENSCHEL MIXER (produced by Mitsui-Miike Kogyo Co., Ltd.) to obtain Toner 1.

| | |
|---|---|
| Hexamethylsilazane-treated silica (with an average | 0.6 weight parts |
| primary particle size of 12 nm) | |
| n-Octylsilane-treated titanium dioxide(with an average | 0.8 weight parts |
| primary particle size of 24 nm) | |

The external treatment in the HENSCHEL MIXER was conducted at 35° C. for 15 minutes under condition of a stirring blade circumferential speed of 35 m/sec.

The thus prepared Toner 1 had a powder X-ray diffraction peak (2θ) at 6.3°, 11.1°, 13.0°, 16.6°, 22.5°, 23.8° and 27.0°.

### Example 2

### Preparation of Toner Via Emulsion Coagulation Method

### (1) Preparation of Colorant Particle Dispersion 1

Sodium n-dodecylsulfate of 11.5 weight parts was poured in 160 weight parts of deionized water and dissolved with stirring to prepare an aqueous surfactant solution. C.I. Pigment Blue 60 (δ type) of 4 weight parts was gradually added to this aqueous surfactant solution and dispersed using CLEAR MIX W-motion CLM-0.8 (produced by M Technique Co.) to obtain Colorant Particle Dispersion 1. C.I. Pigment Blue 60 (δ type) as described above had a powder X-ray diffraction peak (2θ) at 6.3°, 11.1°, 13.0°, 16.6°, 22.5°, 23.8°, and 27.0°.

Colorant Particle 1 contained in the Colorant Particle Dispersion 1 exhibited a volume-based median diameter of 98 nm. The volume-based median diameter was measured under the following conditions using MICROTRAC UPA-150 (produced by HONEYWELL Corp.).

| | |
|---|---|
| Sample refractive index: | 1.59 |
| Sample specific gravity: | 1.05 (in terms of spherical |
| | particle) |
| Solvent refractive index: | 1.33 |
| Solvent viscosity: | 0.797 (30° C.), 1.002 (20° C.) |
| Zero-point adjustment: | adjusted by adding deionized water |
| | to the measurement cell. |

(2) Preparation of Core Resin Particle 1 Core resin particle 1 having a multilayer structure was prepared through a first polymerization, a second polymerization and a third polymerization as described below.

### (a) First Polymerization

Into a reaction vessel fitted with a stirrer, a temperature sensor, a condenser and a nitrogen gas-introducing device was placed 4 weight parts of an anionic surfactant represented by the following formula 1 together with 3040 weight parts of deionized water to prepare an aqueous surfactant solution.

C₁₀C²¹(OCH₂CH₂)₂SO₃Na Formula 1:

A polymerization initiator solution in which 10 weight parts of potassium persulfate (KPS) were dissolved in 400 weight parts of deionized water was added to the foregoing aqueous surfactant solution, and heated to 75° C. Then, a mixed monomer solution comprised of the following compounds was dropwise added to the reaction vessel in 1 hr.

| | | |
|---|---|---|
| Styrene | 532 | weight parts |
| n-Butyl acrylate | 200 | weight parts |
| Methacrylic acid | 68 | weight parts |
| n-Octyl mercaptan | 16.4 | weight parts |

After completing addition of the mixed monomer solution the resulting reaction mixture was heated with stirring at 75° C. for 2 hours to undergo polymerization (first polymerization) to obtain a first resin particle dispersion. The resin particles in the resulting first resin particle dispersion were designated as Resin Particle A1. The weight average molecular weight of the Resin Particle A1 prepared in the first polymerization was 16,500.

### (b) Second Polymerization

A mixed monomer solution comprised of the following compounds was introduced into a flask fitted with a stirrer. Successively, 93.8 weight parts of paraffin wax HNP-57 (produced Nippon Seiro Co., Ltd.) as a releasing agent was added thereto and dissolved with heating at 90° C. to prepare a paraffin wax-containing monomer solution.

| | |
|---|---|
| Styrene | 101.1 weight parts |
| n-Butyl acrylate | 62.2 weight parts |
| Methacrylic acid | 12.3 weight parts |
| n-Octyl mercaptan | 1.75 weight parts |

An aqueous surfactant solution was prepared by dissolving 3 weight parts of the above anionic surfactant in 1560 weight parts of deionized water and heated at 98° C. The above-obtained Resin Particle A1 in an amount of 32.8 weight parts (in terms of solid) was added to the resulting aqueous surfactant solution, further added with the paraffin wax-containing monomer solution described above, and dispersed for 8 hours in a mechanical stirrer having a circulation path, CLEARMIX (produced by M Technique Co.). Thus, an emulsified particle dispersion containing emulsified particles having a dispersion particle size of 340 nm was prepared.

Subsequently, a polymerization initiator solution in which 6 weight parts of potassium persulfate were dissolved in 200 weight parts of deionized water was added to the emulsified particle dispersion obtained above. The resulting mixture was heated at 98° C. for 12 hours to undergo polymerization (second polymerization) to prepare a second resin particle dispersion. The resin particles in the resulting second resin particle dispersion were designated as Resin Particle A2. The weight average molecular weight of the Resin Particle A2 prepared in the second polymerization was 23,000 .

### (c) Third Polymerization

A polymerization initiator solution in which 5.45 weight parts of potassium persulfate were dissolved in 220 weight parts of deionized water was added to the second resin particle dispersion obtained above in the second polymerization step and dropwise added with a mixed monomer solution comprised of the following compounds at 80° C. in one hour.

| | |
|---|---|
| Styrene | 293.8 weight parts |
| n-Butyl acrylate | 154.1 weight parts |
| n-Octyl mercaptan | 7.08 weight parts |

After completing addition, the reaction mixture was heated with stirring for 2 hours to undergo polymerization (third polymerization). After completion of polymerization, the resulting mixture was cooled to 28° C. to obtain a third resin particle dispersion. The resin particles in the resulting third resin particle dispersion were designated as Core Resin Particle 1. The weight average molecular weight of the Core Resin Particle 1 prepared in the third polymerization was 26,800.

### (3) Preparation of Shell Resin Particle 1

A shell resin particle dispersion was prepared in the same manner as in the first polymerization above, except that the mixed monomer solution used in the first polymerization was changed to the following mixed monomer solution. The resin particles in the resulting shell resin particle dispersion were designated as Shell Resin Particle 1.

| | | |
|---|---|---|
| Styrene | 624 | weight parts |
| 2-Ethylhexyl acrylate | 120 | weight parts |
| Methacrylic acid | 56 | weight parts |
| n-Octyl mercaptan | 16.4 | weight parts |

### (4) Preparation of Toner 2

Toner 2 was prepared in the following manner.

### (a) Formation of Core

The following composition was introduced into a reaction vessel fitted with a stirrer, a temperature sensor, a condenser and a nitrogen gas introducing device, and stirred.

| | |
|---|---|
| Core Resin Particle 1 | 420.7 weight parts |
| | (in terms of solid) |
| Deionized water | 900 weight parts |
| Colorant Particle Dispersion 1 | 200 weight parts |

The resulting mixture was adjusted to 30° C. and added with an aqueous 5 mol/L sodium hydroxide solution to give a pH of 8 to 11.

Subsequently, an aqueous solution in which 2 weight parts of magnesium chloride hexahydrate were dissolved in 1000 weight parts of deionized water was added thereto at 30° C. in 10 minutes. After allowed to stand for 3 minutes, the mixture was heated to 65° C. in 60 minutes to perform coagulation of particles. Using Multisizer 3 (produced by Beckman Coulter Co.), the particle size of the coagulated particles in the mixture was measured, and when the coagulated particles reached a volume-based median diameter of 5.5 μm, the mixture was added with an aqueous solution in which 40.2 weight parts of sodium chloride were dissolved in 1000 weight parts of deionized water to terminate coagulation.

After terminating coagulation, ripening was conducted at 70° C. for 1 hour to allow fusion to continue, whereby a core dispersion was prepared. The core particles in the core dispersion were designated as Core 1.

The average circularity of the Core 1 in the core dispersion was 0.912, measured by FPIA 2100 (produced by SISMECS Co.).

### (b) Formation of Shell

Subsequently, 96 weight parts (in terms of solid) of Shell Resin Particle 1 was added to the above-obtained core dispersion maintained at 65° C., and an aqueous solution, in which 2 weight parts of magnesium chloride hexahydrate were dissolved in 1000 weight parts of deionized water, was further added thereto in 10 minutes. The resulting mixture was heated to 70° C. and stirred for 1 hour. Thus, the Shell Resin Particle 1 was fusion-adhered onto the surface of the Core 1 and then ripening was carried out at 75° C. for 20 minutes to form a shell.

Thereafter, an aqueous solution in which 40.2 weight parts of sodium chloride were dissolved in 1000 weight parts was added to terminate shell formation. The reaction mixture was cooled to 30° C. at a cooling rate of 8° C./minute, and filtered off to obtain colored particles. The colored particles were repeatedly washed with 45° C. detonized water, and dried with 40° C. hot air. Thus, Colored Particle 2 having a shell on the core surface was prepared.

### (c) External Additive Treatment

Subsequently, 100 weight parts of the Colored Particle 2 obtained above were added with the following external additives and subjected to external treatment with stirring in a HENSCHEL MIXER (produced by Mitsui-Miike Kogyo Co., Ltd.) to prepare Toner 2.

| | |
|---|---|
| Hexamethylsilazane-treated silica (average | 0.6 weight parts |
| primary particle size of 12 nm) | |
| n-Octylsilane-treated titanium oxide(average | 0.8 weight parts |
| primary particle size of 24 nm) | |

The external treatment in a HENSCHEL MIXER was conducted at 35° C. for 15 minutes under condition of a stirring blade circumferential speed of 35 m/sec

The thus prepared Toner 2 had a powder X-ray diffraction peak (2θ) at 6.3°, 11.1°, 13.0°, 16.6°, 22.5°, 23.8° and 27.0°.

### Comparative Example 1

### Preparation of Toner 3

Toner 3 was prepared in the same manner as in Example 1, except that copper phthalocyanine was used instead of C.I. Pigment Blue 60 (δ type).

### Comparative Example 2

### Preparation of Tone 4

Toner 4 was prepared in the same manner as in Example 2, except that copper phthalocyanine was used instead of C.I. Pigment Blue 60 (δ type).

### Preparation Example 1 of Yellow Toner

Yellow Toner 1 was prepared in the same manner as in Example 2, except that Pigment Yellow 74 was used instead of C.I. Pigment Blue 60 (δ type).

### Preparation Example 2 of Yellow Toner

Yellow Toner 2 was prepared in the same manner as in Example 2, except that Pigment Yellow 74 was used instead of C.I. Pigment Blue 60 (δ type).

### Preparation Example 1 of Magenta Toner

Magenta Toner 1 was prepared in the same manner as in Example 1, except that Pigment Red 122 was used instead of C.I. Pigment Blue 60 (δ type).

### Preparation Example 2 of Magenta Toner

Magenta Toner 2 was prepared in the same manner as in Example 2, except that Pigment Red 122 was used instead of C.I. Pigment Blue 60 (δ type).

### Preparation Example 1 of Black Toner

Black Toner 1 was prepared in the same manner as in Example 1, except that carbon black MOGUL L was used instead of C.I Pigment Blue 60 (δ type).

### Preparation Example 2 of Black Toner

Black Toner 2 was prepared in the same manner as in Example 2, except that carbon black MOGUL L was used instead of C.I. Pigment Blue 60 (δ type).

### Preparation of Developer

Each of Toners 1, 2, 3 and 4, Yellow Toners 1 and 2, Magenta Toners 1 and 2 and Black Toners 1 and 2 was mixed with ferrite carrier covered with methyl methacrylate-cyclohexyl methacrylate copolymer resin having a volume-based median diameter of 50 μm to prepare Developers 1, 2, 3 and 4, Yellow Developers 1 and 2, Magenta Developers 1 and 2, and Black Developers 1 and 2, respectively, each developer having a toner content of 6%.

### 2. Evaluation

Evaluation was conducted using a commercially available, multi-functional printer, bizhub Pro C500 (produced by Monica Minolta Business Technology Inc.) corresponding to an image formation apparatus of a two-component development system, as illustrated in FIG. 1, in which the developing device was charged with each of the developers.

A combination of the developers is as follows.

### (Inventive Developer 1)

Developer 1/Yellow Developer 1/Magenta Developer 1/Black Developer 1

### (Inventive Developer 2)

Developer 2/Yellow Developer 2/Magenta Developer 2/Developer 4/Black Developer 2

### (Comparative Developer 1)

Developer 3/Yellow Developer 1/Magenta Developer 1/Black Developer 1

### (Comparative Developer 2)

Developer 4/Yellow Developer 2/Magenta Developer 2/Black Developer 2

The developers-as described above, in which four or five kinds of developers were combined, ware evaluated as follows.

### (Evaluation of Color Reproduction Region of Full Color Image)

Employing the developers obtained above, a 2 cm×2 cm solid image of each of a monochromatic yellow (Y) color, a monochromatic magenta (M) color, a monochromatic cyan (C) color, a monochromatic red (R) color, a monochromatic blue (B) color and a monochromatic green (G) color was formed at 20° C. and at 50% RH. The color gamut thereof was represented on the a*-b* coordinate, and the area thereof was determined. With respect to each developer, an area (color gamut area) composed of color gamut of Y/M/C/R/G/B was determined, and the color gamut area of other developers was represented by a value relative to that of Comparative Developer 1 set at 100, whereby the color reproduction region with respect to each developer was evaluated. The results are shown as follows.

| | |
|---|---|
| Inventive Developer 1 | Color gamut area = 119 |
| Inventive Developer 2 | Color gamut area = 128 |
| Comparative Developer 1 | Color gamut area = 100 |
| Comparative Developer 2 | Color gamut area = 102 |

As is apparent from the above, it has proved that the inventive developers employing the toner of the invention for developing an electrostatic image increase color gamut area, that is, color reproduction region.

### Light Fastness:

A cyan image with a size of 10 cm×10 cm was formed employing Inventive Developers 1 and 2 and Comparative Developers 1 and 2. The resulting cyan image was subjected to exposure of 70,000 lux over a period of 480 hours employing a xenon weather meter XL75. The image reflection densities before and after exposure were measured. Then, the reflection density variation (%) between before and after exposure was determined, and evaluated as a measure of light fastness. Herein, the reflection density variation (%) before and after exposure is represented by the following formula:

Reflection density variation (%) before and after exposure=(Reflection density before exposure Reflection density after exposure)×100/Reflection density before exposure

The results are shown below.

| | |
|---|---|
| Inventive Developer 1 | Reflection density variation = 0% |
| Inventive Developer 2 | Reflection density variation = 0% |
| Comparative Developer 1 | Reflection density variation = 8.7% |
| Comparative Developer 1 | Reflection density variation = 8.7% |

As is apparent from the above, an image formed employing the toner of the invention for developing an electrostatic image has excellent light fastness.

Inventive Developers 1 and 2 comprising the toner of the invention provide an image without toner scattering around dots in the half-tone regions and high dot formation accuracy. Accordingly, an image formed employing Developer 1 or 2 has extremely excellent brightness in the green and blue regions, as compared with that formed employing Comparative Developer 1 or 2.

What is claimed is:

1. A toner for developing an electrostatic image comprising at least a resin and a colorant, wherein the colorant includes C.I. Pigment Blue 60 having a powder X-ray diffraction peak (2θ) at 6.3±0.2° and 13.0±0.2°.

2. The toner for developing an electrostatic image of claim 1, wherein the C.I. Pigment Blue 60 further has a powder X-ray diffraction peak (2θ) at 111±0.2°, 16.6±0.2°, 22.5±0.2°, 23.8±0.2° and 27.0±0.2°.

3. The toner for developing an electrostatic image of claim 1, wherein the toner has a powder X-ray diffraction peak (2θ) at 6.3±0.2° and 13.0±0.2°.

4. The toner for developing an electrostatic image of claim 3, wherein the toner further has a powder X-ray diffraction peak (2θ) at 11.1±0.2°, 16.6±0.2°, 22.5±0.2°, 23.8±0.2° and 27.0±0.2°.

5. The toner for developing an electrostatic image of claim 1, wherein the toner has a volume-based median diameter of from 3 to 8 μm.

6. The toner for developing an electrostatic image of claim 1, wherein the toner has a coefficient of variation of from 2 to 21% in the volume-based particle size distribution.

7. The toner for developing an electrostatic image of claim 1 wherein the toner has a softening point (Tsp) of from 70 to 110° C.

8. The toner for developing an electrostatic image of claim 1, wherein the content of the resin in the toner is from 60 to 95 weight %.

9. The toner for developing an electrostatic image of claim 1, wherein the content of the C.I. Pigment Blue 60 in the toner is from 1 to 10 weight %.

10. A full color toner kit comprised of at least a yellow toner comprising at least a yellow colorant and a resin, a magenta toner comprising at least a magenta colorant and a resin, a toner comprising at least C.I. Pigment Blue 60 and a resin, and a black toner comprising at least a black colorant and a resin, wherein the C.I. Pigment Blue 60 has a powder X-ray diffraction peak (2θ) at 6.3±0.2° and 13.0±0.2°.

11. The full color toner kit of claim 10, wherein the C.I. Pigment Blue 60 further has a powder X-ray diffraction peak (2θ) at 11.1±0.2°, 16.6±0.2°, 22.5±0.2°, 23.8±0.2° and 27.0±0.2°.

12. A full color toner kit comprised of a yellow toner comprising at least a yellow colorant and a resin, a magenta toner comprising at least a magenta colorant and a resin, a cyan toner comprising at least a cyan colorant and a resin, a blue toner comprising at least C.I. Pigment Blue 60 and a resin, and a black toner comprising at least a black colorant and a resin, wherein the C.I. Pigment Blue 60 has a powder X-ray diffraction peak (2θ) at 6.3±0.2° and 13.0±0.2°.

13. The full color toner kit of claim 12, wherein the C.I. Pigment Blue 60 further has a powder X-ray diffraction peak (2θ) at 11.1±0.2°, 16.6±0.2°, 22.5+0.2°, 23.8±0.2° and 27.0±0.2°.

14. An image formation method comprising the step of forming an image employing a yellow toner comprising at least a yellow colorant and a resin, a magenta toner comprising at least a magenta colorant and a resin, a toner comprising at least C.I. Pigment Blue 60 and a resin, and a black toner comprising at least a black colorant and a resin, wherein the C.I. Pigment Blue 60 has a powder X-ray diffraction peak (2θ) at 6.3±0.2° and 13.0±0.2°.

15. An image formation method comprising employing a yellow toner comprising at least a yellow colorant and a resin, a magenta toner comprising at least a magenta colorant and a resin, a cyan toner comprising at least a cyan colorant and a resin, a blue toner comprising a blue colorant and a resin, and a black toner comprising at least a black colorant and a resin, wherein the blue toner comprises C.I. Pigment Blue 60 having a powder X-ray diffraction peak (2θ) at 6.3±0.2° and 13.0±0.2°.
